(19) United States
(12) Patent Application Publication
(10) Pub. No.: US 2020/0281403 A1
(43) Pub. Date: Sep. 10, 2020

(54) FIRE BASKET

(71) Applicants: Thomas KAISER, Schrattenbach (DE); Christian WASSERMANN, Ebenhofen (DE)

(72) Inventors: Thomas KAISER, Schrattenbach (DE); Christian WASSERMANN, Ebenhofen (DE)

(21) Appl. No.: 16/648,884

(22) PCT Filed: Sep. 20, 2018
(86) PCT No.: PCT/EP2018/000439

§ 371 Date: Mar. 19, 2020

(30) Foreign Application Priority Data
Sep. 20, 2017 (DE) 20 2017 004 859.0

(51) Int. Cl. A47J 37/07; F24B 1/182; F24B 1/195; B65D 25/30; B67B 7/16; B65D 6/02; B65D 21/02; B65D 81/36

(52) U.S. Cl. CPC A47J 37/0704; F24B 1/182; F24B 1/195; B65D 81/365; B67B 7/16; B65D 7/065; B65D 21/0215; B65D 25/30

(57) ABSTRACT

The aim of the invention is the simple operation and handling of a fire basket (1) for wood and similar combustibles, comprising a heat-resistant bottom for forming a fire pan and a jacket adjoining the same in the upward direction. This aim is achieved, according to the invention, in that the jacket (3) is in the form of a stacking crate (4) made of sheet metal. At least one bottle opener (5) is preferably provided in the jacket (3), in particular punched in or cut out adjacent to the corner region of the beverage crate, and spacers (6), in particular for beverage bottles, are inserted in the stacking crate (4) upon delivery.

The invention relates to a fire basket for wood and similar fuels, according to features of the preamble of claim 1.

Such fire baskets are used outdoors (garden, terrace, etc.) in the form of a mobile campfire. From DE 202 10 747 U1, a “pot-shaped” fire basket with a grill top is known, which comprises a slotted sheathing so sufficient air can reach the fuel. However, it is problematic that such a bulky fire basket is difficult to transport, e.g. because of the lack of handles. As barbecue sites can often only be reached by foot and all barbecue utensils often have to be carried over long distances, DE 202 16 661 proposed a barbecue construction set in which a container for barbecue coal is shaped such that it can be placed on a commercially available beverage crate in a space-saving manner and thus be carried as a unit. At the barbecue site, the charcoal bag is removed from the beverage crate together with a metal base tray and then ignited at a certain distance from the beverage crate, as the latter consists of plastic and is therefore not heat-resistant. In addition, the unit consisting of the base tray and the charcoal bag has only a short burning time, so that this unit is not suitable for lighting and/or as a heat source in later evening hours after the barbecue. In addition, the base tray is placed directly on the ground, so that the operators have to bend down to add barbecue items to the barbecue or turn them over, which is very cumbersome.

Therefore such a fire basket should be improved regarding usability and handling.

This task is solved by the features of claim 1. Advantageous implementations are subject of the dependent claims.

The proposed fire basket can be manufactured in a relatively inexpensive and stable manner, in particular from sheet steel, and can also be used as an outdoor grill. Company logos, emblems etc. can be punched or cut into the outer wall or the sheathing of the fire basket for the burning material thus shaped, which also increases the air supply to the burning material, mostly wooden logs. By the at least largely closed bottom of the fire basket made of sheet metal, the ground is protected from fire damage and the combustible material or embers cannot fall out of the fire basket due to the downwardly closed shape. The users are also largely protected against flying sparks, whereby air can flow around the upper carrying handles of the metal stackable crate and can thus be touched at least with gloves, e.g. to move the fire basket with burning wood at the barbecue area.

Due to the shape of a stackable crate, preferably beverage crate, of the fire basket, the apertures or openings provided as carrying handles create the pleasant impression of an open fire when the fire basket is in operation. After the fire is extinguished, the fire basket and the fire residues inside can cool down relatively quickly, as the fire basket is made of sheet steel, possibly of stainless steel or aluminum, and offers a large cooling surface.

At the proposed metal stackable crate there are formed at least two, preferably four hand or carrying handles, so that this fire basket can be carried comfortably. A bottle opener is preferably formed into the sheathing at the corner of the fire basket (near the handles), so that it is practically always at hand and cannot get lost. The opening for the bottle opener can be easily incorporated into the outer wall of the fire basket by punching or laser cutting, whereby the metal construction of the sheathing ensures sufficient stability.

In addition, the fire basket and/or its sheathing can be closed with a lid at the upper end, which in particular forms a seat. A grill grate can also be placed during operation, which can be hung on the sheathing in various height positions. At the lower end of the fire basket four short support feet are preferably provided, which are preferably integrally formed at low cost, i.e. which are formed e.g. when punching out or laser cutting the sheet steel. In this way, a safety distance to the ground is maintained and lateral slipping is prevented when stacking several fire baskets on top of each other (e.g. to increase their lighting effect or to set a comfortable working height). This also applies to the logistics of such stackable crates as fire baskets, in particular if they are (largely) filled with beverage bottles. A relatively high stack can be moved with a forklift truck, for example in order to effectively supply large events. However, also barbecue accessories, such as containers for fire starter etc., can also be filled into the beverage crate compartments. The compartments as spacers for the beverage bottles is preferably designed as a cardboard strip grid, so that it can also be used to light a fire in the fire basket. By interlocking the support feet in the stable, frame-like sheathing, several fire baskets can be stacked on top of each other in a columnar manner, so that relatively high but stable columns can be erected by this positive engagement, e.g. to increase the illumination by fires then burning on several levels: This results in special lighting effects, especially at larger evening events, due to the “open” fires on several levels, in particular with backlighting of the opened logos or emblems, e.g. of the organizer or sponsor, as well as a pleasant heat development, e.g. at a height of 0.7 and 1.4 meters from the ground, especially at cooler outside temperatures. In addition, the fire baskets can be stacked in a space-saving manner and thus be stored in a space-saving manner, e.g. at regularly occurring events. With the stackable crates, the “working height” can be adjusted, e.g. with the grill grate in place, so that the operation is very convenient. Two stackable crates of this type, designed as fire baskets, can be used to create a comfortable seat, or three stackable crates on top of each other to create a table surface. Since each stackable crate is designed as a fire basket, a dozen of these fire baskets can be distributed around the party during an event in a ring to provide light and heat.

Further advantages of the invention result from the following description of an implementation example based on the drawings. The figures show:

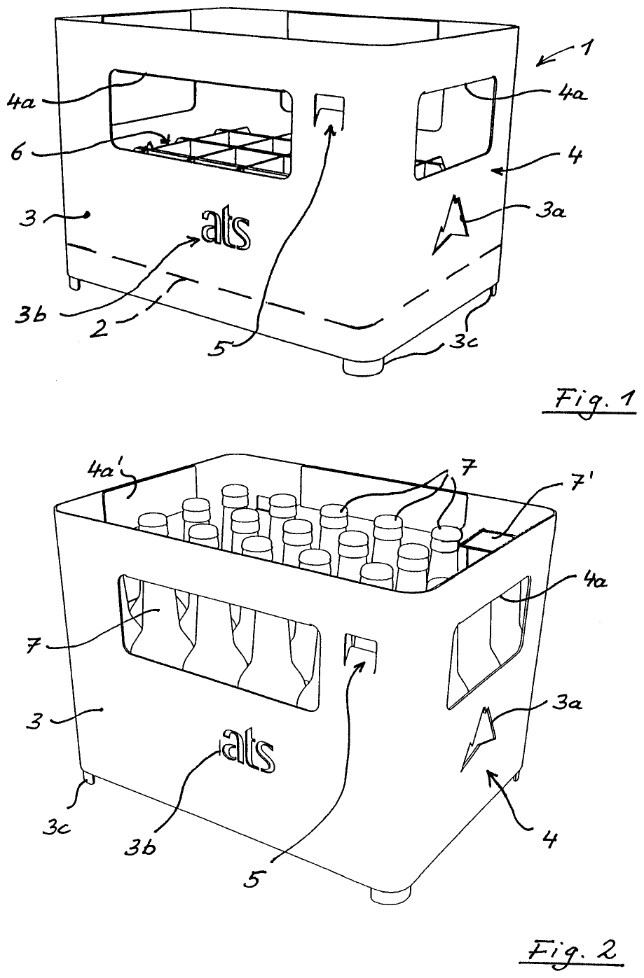

FIG. 1 a perspective representation of a fire basket,

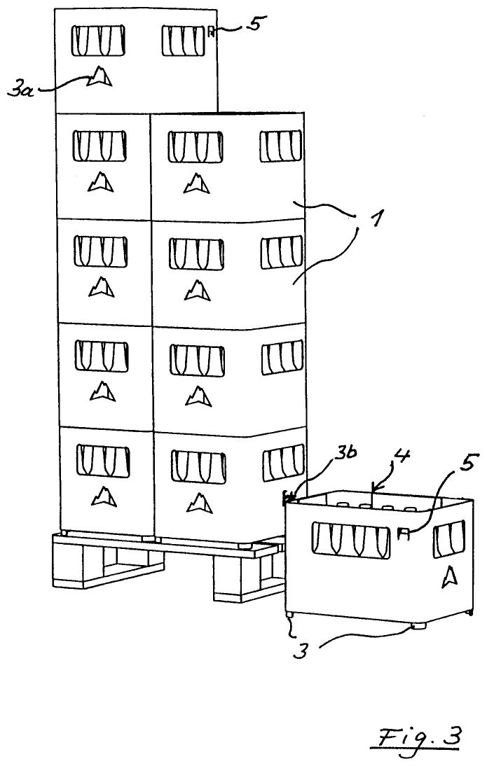

FIG. 2 a perspective view of the fire basket as shown in FIG. 1 in filled position, and

FIG. 3 a representation with several fire baskets stacked on top of each other.

FIG. 1 shows a fire basket 1 for the combustion of wood and/or similar fuels (such as barbecue coal) and consists of a heat-resistant bottom 2 indicated by dashed lines, which is encompassed or surrounded by a sheathing 3. The sheathing 3, which is formed of metal, preferably sheet steel, comprises several (preferably punched out) openings in its upper region as carrying handles 4a, so that the shape of a stackable crate 4, in particular a commercially available beverage crate 4, results and the wood burning in fire basket 1 is clearly visible and can illuminate and/or heat the surroundings. These openings also serve to supply combustion air for a uniform combustion. In addition, logos 3a (here a stylized mountain motif) and/or emblems 3b (here the letters “ats” as an example) can be incorporated into the sheathing 3 (especially by laser cutting), so that combustion air can also be supplied through this area of the sheathing 3. The fire basket 1 further comprises support feet 3c, which are preferably manufactured in one piece with the sheathing 3 and serve as a lateral latching in the stacking position (FIG. 3). In addition, a certain distance to the floor space (ground) is maintained through this. The support feet 3c can also be attached as a component to the bottom 2 or the sheathing 3 and each have a conical shape in order to be securely centered with respect to the upper edge of the sheathing 3 when stacking.

In FIG. 2, the stackable crate 4, designed as fire basket 1, is filled with a variety of beverage containers 7 in the shape of standard crown cork bottles, which are positioned by means of grid-shaped spacers 6 (see FIG. 1). The spacers 6 inserted in the stackable crate 4 are preferably made of combustible material such as cardboard, so that they can be used to light the fire in the fire basket 1. In the right-hand corner here, a rectangle indicates a container for grill accessories 7′, e.g. for a fire starter. Other beverage bottles can also be replaced by such grill accessories, e.g. for barbecue coal. In the most common case of use, however, at least the main part of the stackable crate 4 is filled with bottles, which can then be easily opened at the barbecue site with a bottle opener 5, which is punched or laser-cut in the sheathing 3 adjacent to its corner area. The shape with the flap slightly bent towards the inside is shown in DE 20 2013 006 696 of the applicants. This also means that the crown caps fall into the interior of fire basket 1 and not into the surrounding area.

The fire basket 1 is completely made of heat-resistant metal, in particular of easily formable steel sheets. For example, two halves of sheathing 3 can be produced by deep drawing, which are then joined together with bottom 2, in particular welded together. The bottom 2 of fire basket 1 can also be spot welded to a largely circumferential fold of the sheathing 3 in order to achieve high stability even with thin sheet thicknesses. The cut-out flaps for the carrying handles 4a can also be folded up inwards, as indicated by the reference sign 4a′ in FIG. 2, left. This also results in a clean, rounded edge for convenient carrying of the stackable crate 4, e.g. to a barbecue site. A plate-shaped seat 7 can also be placed on top of the stackable crate 4, which can then be replaced by a (rectangular) grill grate for grilling.

In FIG. 3, several fire baskets 1 are stacked on top of each other in a columnar manner, as they can be offered, for example, in a beverage market or a brewery filled with beer bottles. After transport (by car or also by truck with forklift truck at large events) to a barbecue site, the beverage crate 4 (shown here on the right in single form) can be used as fire basket 1, whereby the beverage containers 7 (and additional barbecue accessories 7′ if necessary) are removed. The beer bottles filled in here, for example, can be conveniently opened at the “integrated” bottle opener 5, whereby the bottle opener 5 can practicably not be lost.

Several fire baskets 1 or boxes 4 (without bottle contents) may also be stacked on top of each other at the site of use, resulting in a raised seating or table surface. For an improved lighting effect, even four or five fire baskets 1 can be stacked on top of each other in a columnar manner, as shown here in FIG. 3, wherein the positive engagement of the support feet 3c within the stable, frame-like sheathing 3 results in exact, secure positioning. Through the apertures for the support handles 4a, logs can be conveniently loaded from all sides such that increased lighting and also heat emission is achieved, which is particularly desirable on cooler evenings. During the event the fire basket stacks can also be converted, as each stackable crate 4 can serve as fire basket 1. For example, four stacks of five stackable crates 4 each (e.g. a pallet load) can be individually converted into a ring around a group of e.g. ten people, i.e. set up surrounding the barbecue area to provide light and heat for this group.

1-9. (canceled)

10. A fire basket for wood and similar fuels with a heat-resistant bottom for forming a fire bowl and a sheathing adjoining it towards the top, the fire basket is formed in the shape of a stackable crate of sheet metal, wherein the fire basket is in the form of a beverage crate with an at least largely closed bottom and the sheathing has openings provided in its upper region as carrying handles.

11. The fire basket of claim 10, wherein the sheathing has two opposing long sides and in comparison thereto two opposing narrow sides and the openings provided as carrying handles are present at the narrow sides.

12. The fire basket of claim 11, wherein openings provided as carrying handles are present at the long sides.

13. The fire basket of claim 11, wherein the sheathing has several openings in addition to the carrying handles.

14. The fire basket of claim 10, wherein the carrying handles are each provided with an envelope flap.

15. The fire basket of claim 10, wherein at least one bottle opener is provided in the sheathing.

16. The fire basket of claim 15, wherein adjacent to a corner region of the beverage crate the bottle opener is punched or cut out.

17. The fire basket of claim 16, wherein the bottle opener is formed into the sheathing close to a handle.

18. The fire basket of claim 10, wherein the sheathing or the bottom comprises support feet which are integrally formed or attached thereto.

19. The fire basket of claim 10, wherein the bottom of the fire basket is welded to the sheathing.

20. The fire basket of claim 10, wherein the bottom of the fire basket is spot-welded at a largely circumferential fold to the sheathing.

21. The fire basket of claim 10, wherein spacers are inserted in the stackable crate.

22. The fire basket of claim 21, wherein the spacers are made of combustible material.

23. The fire basket of claim 21, wherein the spacers are made of cardboard.

24. The fire basket of claim 21, wherein the stackable crate is at least partially filled with beverage containers.

25. The fire basket of claim 10, wherein a seat or grill grate is placed on the stackable crate.

26. The fire basket of claim 10, wherein the seat and/or the grill grate are adjustable in height

27. The fire basket of claim 18, wherein interlocking of the support feet in the sheathing is possible so that several fire baskets can be stacked on top of each other in a columnar manner.

28. Method for use of a fire basket, wherein the fire basket has a heat-resistant bottom for forming a fire bowl and a sheathing adjoining it towards the top, the fire basket is formed in the shape of a stackable crate of sheet metal, wherein the fire basket is in the form of a beverage crate with an at least largely closed bottom and the sheathing has openings provided in its upper region as carrying handles, wherein the stackable crate is at least partially filled with beverage containers, comprising the steps of removing beverage containers from the stackable crate and lighting a fire in the fire basket after the removal of the beverage containers.

29. Method for use of a fire basket, wherein the fire basket has a heat-resistant bottom for forming a fire bowl and a sheathing adjoining it towards the top, the fire basket is formed in the shape of a stackable crate of sheet metal, wherein the fire basket is in the form of a beverage crate with an at least largely closed bottom and the sheathing has openings provided in its upper region as carrying handles, wherein several fire baskets are stacked on top of each other in a columnar manner in order to increase an illumination by fires then burning on several levels.
